(19) United States
(12) Patent Application Publication
(10) Pub. No.: US 2024/0217823 A1
(43) Pub. Date: Jul. 4, 2024

(54) HIGH PERFORMANCE (MESOPHASE) CARBON FIBER FEEDSTOCK PRODUCTION

(71) Applicant: UOP LLC, Des Plaines, IL (US)

(72) Inventors: Jan de Ren, Bracknell (GB); Mark Van Wees, Des Plaines, IL (US); Hans Lefebvre, Des Plaines, IL (US); Steven Chmura, Des Plaines, IL (US)

(21) Appl. No.: 18/393,466

(22) Filed: Dec. 21, 2023

Related U.S. Application Data
(60) Provisional application No. 63/435,987, filed on Dec. 29, 2022.

(51) Int. Cl. C01B 32/05; C10C 3/08; C10G 21/14; C10G 21/20

(52) U.S. Cl. CPC C01B 32/05; C10C 3/08; C10G 21/14; C10G 21/20

(57) ABSTRACT

A process is provided for production of a mesophase material that is capable of producing high performance carbon fibers. The mesophase is produced after heavy hydrocarbons have been treated to remove impurities by hydrotreating or quinoline solvent, followed by use of a toluene solvent to remove light hydrocarbons and then being upgraded by a soaker visbreaking step to produce a desirable amount of mesophase material while preventing formation of coke.

This application claims priority to provisional U.S. application 63/435,987, filed Dec. 29, 2022.

The production of carbon fibers from low-cost pitch is known to result in carbon fibers that have poor mechanical properties as compared to carbon fiber prepared from polyacrylonitrile materials. Carbon fibers are a desirable material that have excellent thermal conductivity and electrical conductivity. There is a significant cost savings in the use of carbon fibers made from pitch due to the low cost of the feedstock as compared to PAN which is a result of the high availability of feed from such sources as FCC slurry oil, solvent deasphalting pitch, vacuum tower bottoms, steam cracker heavy pyrolysis oil (tar) and other types of residue.

The term “pitch” denotes a wide range of products that may include both naturally occurring heavy materials and those formed by thermal polymerization of lighter materials. There are two general grades of carbon fiber produced from pitch. These include the use of an istropic pitch to produce lower quality general performance carbon fibers. These carbon fibers have low strength and stiffness and medium thermal and electrical conductivity. These carbon fibers are typically useful in concrete reinforcement, thermal insulation and water treatment. The other type of carbon fiber made from pitch is from a mesophase derived from pitch to produce high performance carbon fibers. These carbon fibers have medium strength and stiffness with excellent thermal and electrical conductivity. The fibers may be used in energy storage such as batteries, fuel cells, supercapacitors electrodes as well as in rollers in the film and papermaking industries and in aircraft brake discs. These fibers can be up to three times more expensive than the general performance carbon fibers. The obstacles faced for the wide spread adoption of pitch-based carbon fiber include the higher cost of carbon fibers compared to glass fiber and steel. In addition, the pitch-based fibers have been very brittle as compared to other PAN based fiber. Among the potential markets for carbon fibers that are produced at lower costs yet with excellent properties is in the automotive industry and for use in batteries for electric vehicles.

A hydrocarbon mesophase feed stock is difficult to use to prepare carbon fibers due to numerous issues including breakage during spinning to make the fibers and the high degree of brittleness of the fibers. This is a result of a lack of an optimal low-cost feed stock for the generation of a clean mesophase feed for the carbon fiber production plant. This invention generates an optimal feedstock to produce high performance carbon fibers—thereby improving the mechanical properties of the carbon fibers and enabling wide adoption of carbon fibers for use in composites such as in the automotive industry as a replacement for steel parts. The lower weight of carbon fiber composites as compared to steel will lead to significant advantages in terms of their use in vehicles including electric vehicles. A more economical high quality precursor material would also be useful in energy storage, specialty asphalt and reinforced plastics and concrete.

Current high quality carbon fiber is prepared from polyacrylonitrile precursor (PAN). However, the use of PAN fiber for carbon fiber production is expensive—therefore limiting its use to specialty/high-tech applications such as military aircraft components. Generating an optimal low-cost, high-performance carbon fiber production feed stock will reduce the overall production cost substantially as well as greatly increase the production volume of carbon fibers available which is desirable due to a large increase in new applications. At the same time, producing high performance carbon fibers using low cost hydrocarbon based feedstocks is an effective means to sequester carbon and effectively address scope 3 emissions.

This disclosure will take the product stream(s) of the described SDA unit(s) and further upgrade it to mesophase to enable high performance carbon fiber production. The upgrading step will essentially be sending the SDA product stream(s) to a soaker visbreaking type step which will operate at a temperature above about 800ºF and have a residence time greater than 2 min to gradually form a desired amount of mesophase, but prevent formation of coke. Once the desired amount of mesophase is produced the product stream will be fed to a carbon fiber production plant to produce the desired high performance carbon fibers. Without this final thermal upgrading step described herein only general performance carbon fibers (GPCF) would be possible to make. It is to be noted that this thermal upgrading step may consist of a staged heating step to maximize temperature control. Furthermore, downstream of the thermal upgrading step there may be one or more separation steps.

### SUMMARY

A process is provided for producing a hydrocarbon feed for converting into carbon fiber, said process comprising sending a raw unhydrotreated feed to be mixed with a solvent to remove solid contaminants and coke that are not soluble in said solvent and wherein hydrocarbons in said raw unhydrotreated feed are soluble in said solvent and then sending said solvent containing said hydrocarbons to a second solvent to remove lighter components and producing a stream comprising heavier hydrocarbon components to be sent to a thermal treatment step to increase the molecular weight of said heavier hydrocarbon components and to produce a pitch to be converted to carbon fiber. The thermal treatment step is a soaker visbreaker step that operates over 800 F and for more than 2 minutes that produces an increase in the amount of desirable mesophase material without producing coke. The mesophase material may then be converted into carbon fiber.

In other embodiments of the invention, the feed may be hydrotreated to remove contaminants and then sent to the second solvent to remove the lighter components before the soaker visbreaking step.

### BRIEF DESCRIPTION OF THE DRAWINGS

FIG. 1 shows a simplified flow scheme for producing a mesophase material to be used as the raw material for carbon fiber.

FIG. 2 shows an alternative flow scheme for producing a mesophase material to be used as the raw material for carbon fiber.

### DETAILED DESCRIPTION

Production of carbon fibers for applications such as aircraft brakes, supercapacitors, steel substitutes for cars and other applications from petroleum residue streams have a lower production cost due to low feedstock cost and high availability of the feed component from refinery streams. However, due to other components within this type of petroleum residue streams, the carbon fibers that are produced from petroleum residue streams often exhibit poor mechanical properties compared to polyacrylonitrile (PAN) based carbon fiber thereby limiting the market adoption of the carbon fibers. These other components include volatile gases, native components within the oil such as sulfur, nitrogen, and organic metal compounds, as well as any residual inorganic material added during processing (FCC catalyst, fines contained within the crude oil, etc.). The present application provides a method for taking a readily available petroleum-based stream and processing it into a feed stock that will allow for direct carbon fiber production and/or carbon fiber production after additional treatment with improved mechanical properties.

Mesophase pitch is an important and only relatively recently recognized member of the pitch family. Mesophase pitch has optical properties and can be used to make carbon fibers, carbon foam and other exotic and valuable materials.

When natural or synthetic pitches having an aromatic base are heated under quiescent conditions at a temperature in the range of 350° C. to 500° C., small insoluble liquid spheres begin to appear in the pitch and gradually increase in size as heating is continued. When examined by electron diffraction and polarized light techniques, these spheres are shown to consist of layers of oriented molecules aligned in the same direction. As these spheres continue to grow in size as heating is continued, they come in contact with one another and gradually coalesce with each other to produce large masses of aligned layers. As coalescence continues, domains of aligned molecules much larger than those of the original spheres are formed. These domains come together to form a bulk mesophase wherein the transition from one oriented domain to another sometimes occurs smoothly and continuously through gradually curving lamellae and sometimes through more sharply curving lamellae. The differences in the orientation between the domains create a complex array of polarized light extinction contours in the bulk mesophase corresponding to various types of linear discontinuity in the molecular alignment. The ultimate size of the oriented domains produced is dependent upon the viscosity and the rate of increase of the viscosity of the mesophase formed, which in turn is dependent upon the particular pitch and the heating rate. In certain pitches, domains having sizes in excess of two hundred microns up to in excess of one thousand microns are produced. In other pitches the viscosity of the mesophase is such that only limited coalescence and structural rearrangement of layers occur so that the ultimate domain size does not exceed one hundred microns.

The highly oriented, optically anisotropic insoluble material produced by treating pitches in this manner has been given the term “mesophase”, and pitches containing such material are known as “mesophase pitches”. Such pitches when heated above their softening points are mixtures of two essentially immiscible liquids, one optically anisotropic oriented mesophase portion and the other the isotropic non-mesophase portion. The term “mesophase” is derived from the Greek “mesos” or “intermediate” and indicates the pseudo-crystalline nature of this highly oriented, optically anisotropic material. Mesophase is in essence a “liquid crystal” since it has an orderly and repeating arrangement of its atoms as evidenced by its X-ray diffraction pattern and yet is capable of flow when stress is applied. This seemingly contradictory behavior results from the rather weak bonding of carbon atoms in adjacent parallel planes.

In a sense, mesophase pitch is just a stopping point along the way of thermal condensation of hydrocarbons into coke. As time and temperature increase, aromatic liquid hydrocarbons thermally polymerize with some thermal de-alkylation. If the atmospheric or vacuum residual of an aromatic crude oil is thermally treated, the first stop is vis-broken crude with a lower viscosity and lower molecular weight than the feed. The next stop along the thermal treatment route is dominated by thermal polymerization yielding petroleum pitch. The end of the line is coke. Mesophase pitch is the penultimate stop. Although the thermal processes can be briefly explained, myriad processes for making mesophase have been proposed or at least patented.

The term pitch has been used for many heavy products, ranging from a residual fraction of crude oil to the product of thermal polymerization. As used herein, pitch is intended to refer to the highly aromatic material with a softening point greater than 100° C. produced by thermal polymerization.

Petroleum pitches have been made for decades by refiners. Perhaps the most widely known material is A-240 pitch and/or M-50 produced by Ashland Petroleum Company and subsequently Marathon Oil Company respectively. Such pitches with suitable softening points can be used satisfactorily as an impregnation material for electrodes, anodes, and carbon-carbon composites, e.g., carbon-carbon fiber composites, such as aircraft brakes and rocket engine nozzles. These pitches can also be used in the nuclear industry for the preparation of fuel sticks and control rods for a graphite moderated reactor. Furthermore, such pitches can be used as a starting material for the production of mesophase pitch which can be used in the production of carbon fiber precursors and carbonized fibers, i.e. carbon fibers and graphite fibers. Carbon foams and other pitch-based products can be made as well from mesophase pitch.

High strength per weight ratio of carbon and graphite fibers, alone or in composites, makes such fibers useful in sporting equipment, automobile parts, light-weight aircraft, and several aerospace applications. High thermal conductivity and strength make carbon foam useful for thermal management applications and more. The end products, carbon fiber, carbon foam and the like, are high value specialty products which rely heavily on the properties of the starting material, the mesophase pitch.

Pitch formation is a thermal process involving thermally induced polymerization. The product has a higher molecular weight than the feed. In contrast, there are other thermal refinery processes which use heat to crack or dehydrate the feed. These processes produce products with lower molecular weights than the feed. Thermal cracking processes such as visbreaking, e.g., a thermal cracking process widely licensed by Universal Oil Products, used high temperature to thermally crack high molecular weight components of crude oil to create its own cutter stock, reducing the viscosity of the heavy fuel oil product. Steam cracking of naphtha or other light, usually paraffinic, feeds to olefins is an important method to produce ethylene and other light olefins. Steam and naphtha are mixed together and fed through a heater at ultra high temperatures as high as 850° C. and at velocities exceeding the speed of sound, then quenched. Styrene production, although catalytic, uses large amounts of superheated steam to heat an ethylbenzene feed to a temperature where it can catalytically and endothermically be converted to styrene. The state of the art on making mesophase pitch could be summarized as follows. There are many processes most involving relatively long batch processes which allow mesophase to form. Some are continuous and use intense mechanical agitation after using a wiped film evaporator to remove a substantial amount of distillate material or agitation by injection of an inert gas. All are difficult to control and, because the temperatures are high, the mesophase pitch precursor and the pitch product can form coke.

For this discussion the unconverted oil stream from a hydrocracking unit provides a very good starting point for the generation of carbon fibers. The unconverted oil from a hydrocracking unit often contains a high concentration of heavy polynuclear aromatics. These need to be removed from the hydrocracking reaction system to prevent catalyst deactivation reactions. In the drawing from U.S. Pat. No. 8,852,404, Line 26 is a concentrated stream of these heavy polynuclear aromatics (HPNA). While the typical drag stream from a hydrocracking application (reference Line 25 in U.S. Pat. No. 8,852,404) also contains some polynuclear aromatics before being concentrated.

Since the net drag stream from a hydrocracking process has already been severely hydrotreated, this HPNA drag stream is typically low in components such as organic sulfur, organic nitrogen, and organic metal compounds. Additionally, this stream does not contain catalyst fines that are often found in other refinery heavy streams that have been examined for the production of carbon fibers (FCC clarified slurry oil (CSO) as well as other thermal cracking residual oils). However, while this stream may be free from typical heavy contaminants, there is still a quantity of undesired lighter materials that can reduce the quality of the final carbon fibers.

Therefore, it is proposed to route this HPNA drag stream to a separation process where these light materials can be removed. Solvent extraction is a process step that can be used to recover light soluble components and rejects insoluble components. The solvent extraction steps may include steps to remove heptane soluble materials such as maltene, toluene soluble materials such as asphaltene, quinoline soluble materials such as beta-Resin leaving a heavy stream of mesophase hydrocarbons.

This heavy product stream from the solvent extraction step now becomes an excellent feed stock for mesophase production due to the large concentration of heavy polynuclear aromatics and for the subsequent production of carbon fibers.

The heavy product stream is kept in a soaker visbreaker drum at a temperature over 800F for over two minutes to gradually form a desired amount of mesophase material which then may be fed to a carbon fiber production plant, visbreaking or thermal cracking achieves moderate conversion of heavy feed to lighter products including an olefinic naphtha. Coking achieves complete conversion of heavy feed to lighter products such as coker naphtha, but the olefin and especially the diene contents of the naphtha are so high that further treatment is needed. Large complex refineries have the specialized equipment needed to process coker naphtha. Typically, either a treatment at relatively low temperature over proprietary catalyst to saturate the dienes or mixing with conventional naphtha and hydrotreating at two to three times the pressure required for the hydrotreating other refinery naphtha fractions is used. The severe hydrotreating of coker naphtha saturates the olefins significantly reducing the octane, so further treatment as in a platinum reformer is needed.

With this lack of heavy contaminants and the removal of the light components, the recovered material can be an excellent feed stream for the production of carbon fibers such as described in other patents (U.S. Pat. No. 9,222,027 and U.S. Ser. No. 10/731,084).

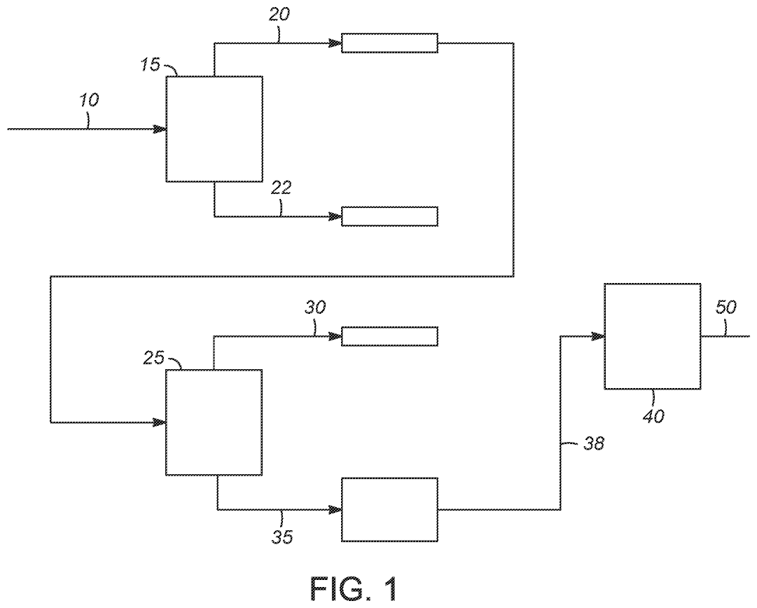

FIG. 1 provides one embodiment of the invention. A petroleum feed 10 is sent to a vessel 15 containing a quinoline solvent to remove contaminants. The materials that not soluble in quinoline exit in line 22. The hydrocarbons are soluble in the quinoline solvent and are sent in stream 20 to a second vessel 25 containing a toluene solvent from which are the toluene soluble light hydrocarbons that are sent in line 30 to be used outside of the current process and a stream 35 of toluene insoluble beta resins that are sent to a soaker visbreaker type reactor 40 that operates at temperatures over 425° C. (800° F.) with material retained in the reactor for over two minutes. The mesophase material 50 that is an anisotropic pitch can now be sent to be converted into carbon fiber.

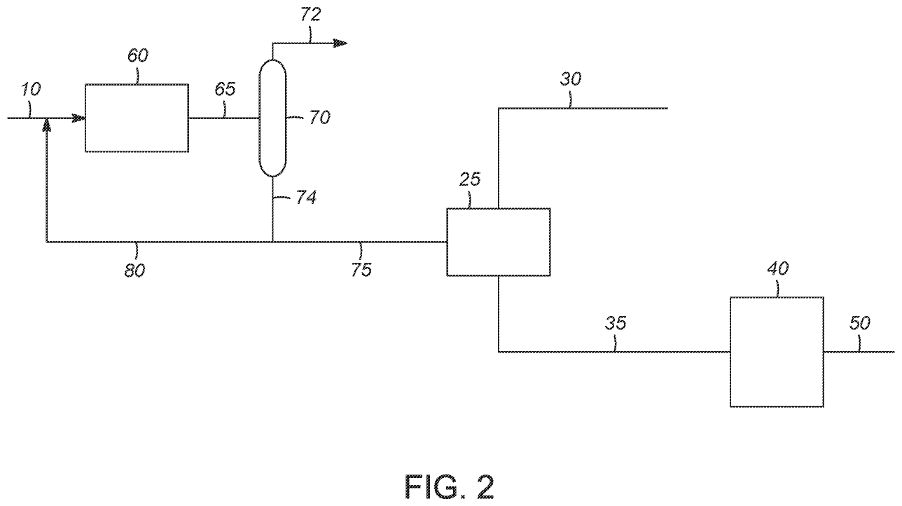

FIG. 2 provides an embodiment of the process in which the treatment with the quinoline solvent is not needed to remove contaminants since the contaminant removal is resolved by the use of a hydrotreating step. In FIG. 2, the feed 10 is sent to a hydrocracking unit 60 with the effluent sent to separation column 70 to be separated into products 72 and heavier hydrocarbons 74. A portion of the heavier hydrocarbons are recycled in stream 80 and a second portion of the heavier hydrocarbons is sent to vessel 30 containing a toluene solvent to separate into a light hydrocarbon stream 30 and a heavy hydrocarbon stream 35 to be sent to soaker visbreaker reactor 40 to produce a mesophase material 50 to be sent to make carbon fiber.

The raw unhydrotreated feed (SDA Pitch or CSO) is first to be treated with quinoline to reject any solid contaminants or coke present in the feed. This solids-free oil (quinoline soluble) may or may not require hydrotreating before being be treated with toluene to remove the lighter components. The heavy components (Beta Resin or toluene insoluble) are then routed to a thermal treatment step (soaker visbreaker) to grow/polymerize the beta resins or small mesophase into larger mosaic mesophase (anisotropic pitch). If isotropic pitch is desired, then the thermal step may be skipped.

If the starting material is already hydrotreated (hydrocracker UCO) then the first quinoline and hydrotreating steps would not be required since the material is already contaminant free. In this permutation the feed is treated with toluene and the toluene insoluble would be sent for thermal treatment.

### EXAMPLE

In this example, clarified slurry oil (CSO) derived from a fluidized catalytic cracking of high molecular weight crude oil was treated using two solvent extraction steps in preparation for further thermal treatment. In the first stage extraction, quinoline was added to CSO in a 10:1 mass ratio to dissolve the oil. The solution was placed in an oil bath, or controlled heating mantle, on a hot plate with vigorous stirring. A thermal couple was inserted into the solution to measure the solution temperature, while a second thermal couple measured the temperature of the oil bath. The solution was heated to 80° ° C. under reflux and is mixed at this temperature for two hours. After two hours, the solution was filtered through a Buchner funnel to separate the quinoline insolubles, collected on filter paper, and the quinoline solubles, collected in the filter flask. The quinoline solubles were rotary evaporated to remove the quinoline. The collected quinoline insoluble and the solvent free quinoline solubles were dried in a vacuum oven at 100° C. for twelve hours.

The purpose of this extraction was to remove ash/catalyst and particulate matter from the CSO feed. If not removed, ash/catalyst and particulate matter contaminants will cause imperfections in the microstructure of the carbon fiber, resulting in unacceptable brittleness. The dried, solvent free quinoline soluble are then subjected to a second extraction. In the second stage extraction heptane is added to the dried, solvent free solubles from the first stage extraction in a 10:1 mass ratio to dissolve the solubles. The solution is placed in an oil bath, or controlled heating mantle, on a hot plate with vigorous stirring. A thermal couple is inserted into the solution to measure the solution temperature, while a second thermal couple measures the temperature of the oil bath. The solution is heated to 80° ° C. under reflux and is mixed at temperature for two hours. After two hours, the solution is filtered through a Buchner funnel to separate the heptane insolubles, collected on the filter paper, and the heptane solubles, collected in the filter flask. The heptane solubles are rotary evaporated to remove the heptane. The collected heptane insolubles and the solvent free heptane solubles are dried in a vacuum oven at 100° C. for twelve hours. The dried, solvent free heptane insolubles are directed for thermal treatment. The purpose of this extraction is to remove any volatiles present in the quinoline solubles as well as to concentrate asphaltene in the HI. If not removed, volatiles components will cause imperfections in the microstructure of the carbon fiber, resulting in unacceptable brittleness.

The dried, solvent free heptane insoluble is then thermally treated at above 426° C. for more than 2 minutes. The heavy hydrocarbons present in the material will form mesophase after treatment and are now a suitable component as feedstock to a carbon fiber production facility.

### SPECIFIC EMBODIMENTS

While the following is described in conjunction with specific embodiments, it will be understood that this description is intended to illustrate and not limit the scope of the preceding description and the appended claims. Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated. A first embodiment of the disclosure is a process for producing a hydrocarbon feed for converting into carbon fiber, said process comprising sending a raw unhydrotreated feed to be mixed with a first solvent to remove contaminants and coke that are not soluble in said solvent and wherein hydrocarbons in said raw unhydrotreated feed are soluble in said first solvent and then sending said first solvent containing said hydrocarbons to a second solvent to remove lighter components and producing a stream comprising heavier hydrocarbon components to be sent to a thermal treatment step to increase the molecular weight of said heavier hydrocarbon components to produce a pitch and then converting said pitch to carbon fiber. An embodiment of the disclosure is one, any or all of prior embodiments in this paragraph up through the first embodiment in this paragraph wherein the first solvent is quinoline. An embodiment of the disclosure is one, any or all of prior embodiments in this paragraph up through the first embodiment in this paragraph wherein the second solvent is toluene. An embodiment of the disclosure is one, any or all of prior embodiments in this paragraph up through the first embodiment in this paragraph wherein the thermal treatment step is above about 425° C. for more than 2 minutes. An embodiment of the disclosure is one, any or all of prior embodiments in this paragraph up through the first embodiment in this paragraph wherein the thermal treatment step increases a proportion of the heavier hydrocarbon components being converted to a mesophase while reducing a proportion of coke to produce a product stream comprising said mesophase. An embodiment of the disclosure is one, any or all of prior embodiments in this paragraph up through the first embodiment in this paragraph further comprising sending the product stream to a carbon fiber production plant to produce carbon fibers having a Young modulus of at least 200 GPa. An embodiment of the disclosure is one, any or all of prior embodiments in this paragraph up through the first embodiment in this paragraph wherein the raw unhydrotreated feed comprises thermally produced pyrolysis oils selected from steam crackers or pyrolysis units or bio derived oils derived from plants, animals, waste greases, algal or microbial sources. An embodiment of the disclosure is one, any or all of prior embodiments in this paragraph up through the first embodiment in this paragraph wherein after the raw unhydrotreated feed is mixed with the solvent to remove solid contaminants, said solvent containing said hydrocarbons is sent to a hydrotreating reactor and then is sent to said second solvent extraction. An embodiment of the disclosure is one, any or all of prior embodiments in this paragraph up through the first embodiment in this paragraph wherein the thermal treatment step is a soaker visbreaker step. An embodiment of the disclosure is one, any or all of prior embodiments in this paragraph up through the first embodiment in this paragraph wherein the heavier hydrocarbon components comprise Beta resin or toluene insoluble hydrocarbons. An embodiment of the disclosure is one, any or all of prior embodiments in this paragraph up through the first embodiment in this paragraph wherein the carbon fiber has a Young's Modulus of at least 200 GPa. An embodiment of the disclosure is one, any or all of prior embodiments in this paragraph up through the first embodiment in this paragraph wherein the heavier hydrocarbon components are converted to an anisotropic pitch.

A second embodiment of the disclosure is a process for producing a hydrocarbon feed for conversion into carbon fiber comprising sending a hydrotreated stream to a vessel containing toluene to produce a stream comprising toluene and impurities removed from said hydrotreated pitch and a solvent insoluble stream; and sending said solvent insoluble stream to a thermal treatment step to produce an anisotropic pitch.

A third embodiment of the disclosure is a process for producing a hydrocarbon feed for converting into carbon fiber, said process comprising sending a raw unhydrotreated feed to be mixed with a first solvent to remove contaminants and coke that are not soluble in said solvent and wherein hydrocarbons in said raw unhydrotreated feed are soluble in said first solvent and then sending said first solvent containing said hydrocarbons to a second solvent to remove lighter components and producing a stream comprising heavier hydrocarbon components to be converted to carbon fiber. An embodiment of the disclosure is one, any or all of prior embodiments in this paragraph up through the first embodiment in this paragraph wherein the carbon fiber has a Young's modulus of at least 50 Gpa.

A fourth embodiment of the disclosure is a process for producing a hydrocarbon feed for converting into carbon fiber, said process comprising sending a raw unhydrotreated feed to be mixed with a solvent to separate lighter hydrocarbon components from heavier hydrocarbon components and then a stream comprising said heavier hydrocarbon components to a solvent to remove contaminants and coke to produce a clean heavier hydrocarbon stream that are not soluble in said solvent and then converting said heavier hydrocarbon stream to carbon fiber.

1. A process for producing a hydrocarbon feed for converting into carbon fiber, said process comprising sending a raw unhydrotreated feed to be mixed with a first solvent to remove contaminants and coke that are not soluble in said solvent and wherein hydrocarbons in said raw unhydrotreated feed are soluble in said first solvent and then sending said first solvent containing said hydrocarbons to a second solvent to remove lighter components and producing a stream comprising heavier hydrocarbon components to be sent to a thermal treatment step to increase the molecular weight of said heavier hydrocarbon components to produce a pitch and then converting said pitch to carbon fiber.

2. The process of claim 1 wherein said first solvent is quinoline.

3. The process of claim 1 wherein said second solvent is toluene.

4. The process of claim 1 wherein said thermal treatment step is above about 425° C. for more than 2 minutes.

5. The process of claim 1 wherein said thermal treatment step increases a proportion of said heavier hydrocarbon components being converted to a mesophase while reducing a proportion of coke to produce a product stream comprising said mesophase.

6. The process of claim 5 further comprising sending said product stream to a carbon fiber production plant to produce carbon fibers having a Young modulus of at least 200 GPa.

7. The process of claim 1 wherein said raw unhydrotreated feed comprises thermally produced pyrolysis oils selected from steam crackers or pyrolysis units or bio derived oils derived from plants, animals, waste greases, algal or microbial sources.

8. The process of claim 1 wherein after said raw unhydrotreated feed is mixed with said solvent to remove solid contaminants, said solvent containing said hydrocarbons is sent to a hydrotreating reactor and then is sent to said second solvent extraction.

9. The process of claim 1 wherein said thermal treatment step is a soaker visbreaker step.

10. The process of claim 1 wherein said heavier hydrocarbon components comprise Beta resin or toluene insoluble hydrocarbons.

11. The process of claim 1 wherein said carbon fiber has a Young's Modulus of at least 200 GPa.

12. The process of claim 9 wherein said heavier hydrocarbon components are converted to an anisotropic pitch.

13. A process for producing a hydrocarbon feed for conversion into carbon fiber comprising sending a hydrotreated stream to a vessel containing toluene to produce a stream comprising toluene and impurities removed from said hydrotreated pitch and a solvent insoluble stream; and sending said solvent insoluble stream to a thermal treatment step to produce an anisotropic pitch.

14. The process of claim 13 wherein said carbon fiber has a Young's modulus of at least 50 Gpa.

15. A process for producing a hydrocarbon feed for converting into carbon fiber, said process comprising sending a raw unhydrotreated feed to be mixed with a first solvent to remove contaminants and coke that are not soluble in said solvent and wherein hydrocarbons in said raw unhydrotreated feed are soluble in said first solvent and then sending said first solvent containing said hydrocarbons to a second solvent to remove lighter components and producing a stream comprising heavier hydrocarbon components to be converted to carbon fiber.

16. The process of claim 15 wherein said carbon fiber has a Young's modulus of at least 50 Gpa.
